(19) United States
(12) Patent Application Publication
(10) Pub. No.: US 2004/0165539 A1
(43) Pub. Date: Aug. 26, 2004

(54) Processing wireless messages to reduce host power consumption

(76) Inventor: Jeffrey L. Huckins, Chandler, AZ (US)

Correspondence Address: Timothy N. Trop, TROP, PRUNER & HU, P.C., STE 100, 8554 KATY FWY, HOUSTON, TX, 77024-1841, US

(21) Appl. No.: 10/372,573

(22) Filed: Feb. 21, 2003

(51) Int. Cl. H04L 12/26

(52) U.S. Cl. 370/252; 370/392

(57) ABSTRACT

An access point in a wireless network may receive packets over a wired network. The access point may be provided with instructions from the host to determine when to involve the host in processing a packet. Thus, the access point can enforce packet filtering rules while the host reduce the station's power consumption.

### BACKGROUND

This invention relates generally to wireless computer networks.

A host processor-based system may communicate with a variety of other devices to form a wireless network. A variety of peripherals and computer systems may be linked together through a wireless network. One protocol for establishing wireless links of this type is the IEEE Std. 802.11 (1999). In such a system, a host may receive packets over the network.

In some cases, the host may be a power consumption sensitive device. One example of such a device is a portable processor-based system that operates from a battery power source. To conserve power, the portable device may power down to a reduced power consumption state.

In the course of network operations, a large number of packets may be passed between various devices on the network. Some of these packets may be important and others may be less important. However, each time a packet is transmitted across the network to a given host, that host must receive the packet and determine whether the packet needs handling.

Thus, there is a need for ways to reduce the power consumption of devices on wireless networks and particularly there is a need for ways to reduce the unnecessary host message handling.

### BRIEF DESCRIPTION OF THE DRAWINGS

FIG. 1 is a schematic depiction of a wireless network in accordance with one embodiment of the present invention;

FIG. 2 is a depiction of a host in accordance with one embodiment of the present invention;

FIG. 3 is a chart that depicts the operation of one embodiment of the present invention;

FIG. 4 is a flow chart for software for the host shown in FIG. 2 in accordance with one embodiment of the present invention;

FIG. 5 is a flow chart for software for the station shown in FIG. 2 in accordance with one embodiment of the present invention;

FIG. 6 is a flow chart for software for an access point shown in FIG. 2, in accordance with one embodiment of the present invention; and

FIG. 7 is a flow chart for software for the server shown in FIG. 2, in accordance with one embodiment of the present invention.

### DETAILED DESCRIPTION

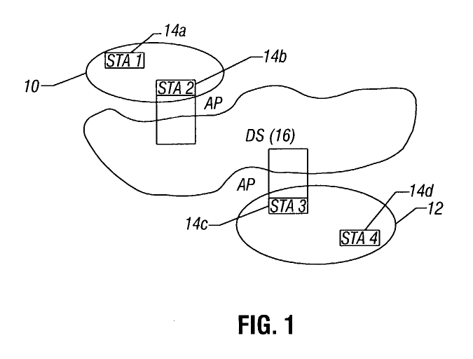

Referring to FIG. 1, a wireless network may include a plurality of basic service sets (BSS) 10 and 12 coupled through a distribution system (DS) 16. The distribution system 16 interconnects the basic service sets 10, 12 in integrated local area networks to create an extended service set. An extended service set is a set of one or more interconnected basic service sets and integrated local area networks that appears as a single basic service set to the logical link control layer at any station associated with one of those basic service sets.

Each basic service set 10 or 12 includes a set of stations (STAs) 14 controlled by a single coordination function. A coordination function is a logical function that determines when a station 14, operating within a basic service set 10 or 12, is permitted to transmit and may be able to receive protocol data units via a wireless medium.

The basic service sets 10 and 12 communicate with the distribution system 16 through access points provided by the stations 14b and 14c. An access point is any entity that has a station functionality while providing access to the distribution services via the wireless medium for associated stations. A station is a device that contains a medium access control (MAC) and a physical layer (PHY) interface to a wireless medium.

In accordance with one embodiment of the present invention, the system shown in FIG. 1 may operate in accordance with the IEEE 802.11 protocol which is set forth in IEEE Std. 802.11, 1999 Edition, available from the IEEE Standards Board, Piscataway, N.J. 08855.

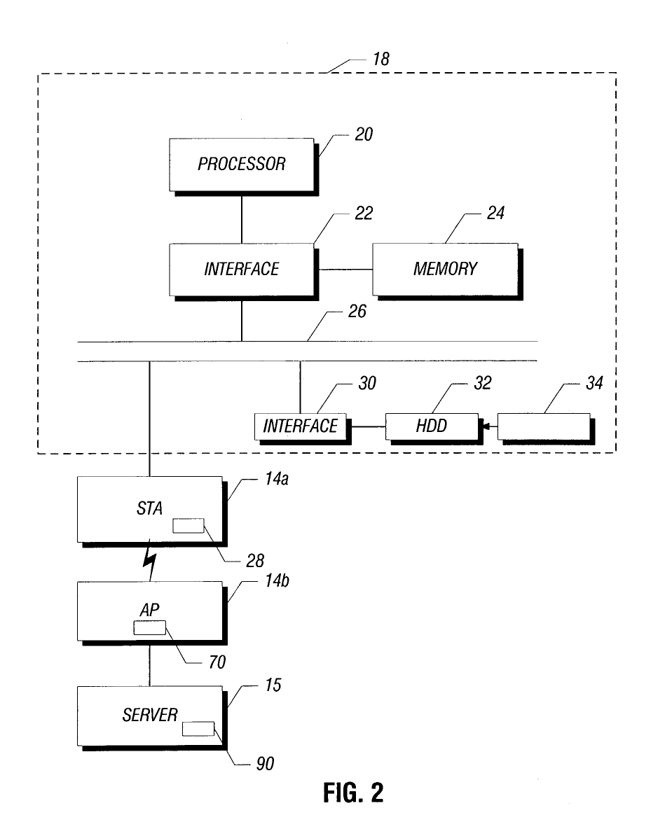

Referring to FIG. 2, the station 14a may communicate with the station 14b that acts as an access point (AP). The station 14a may be associated with a host 18 that in some embodiments may be a processor-based system including a processor 20, an interface 22 and a memory 24. The interface 22, in some embodiments, may be coupled to a bus 26 that receives the station 14a. For example, in one embodiment, the station 14a may be a network interface card (NIC) that is plugged into the bus 26. In another embodiment the station 14a is an access point as well.

The bus 26 may also support an interface 30 that is coupled to a hard disk drive 32. The drive 32 may in turn store a software program 34.

The access point 14b may be coupled over a wired network to an information services server 15 in one embodiment. The server 15 may store software 90. The access point 14b may store software 70 and may be a processor-based system in one embodiment. The station 14a may be a processor-based system and may store the software 28 in one embodiment of the present invention.

In order to reduce the burden on the station 14a and thereby to reduce its power consumption, the system may be server driven in that the information services server 15 sends notification messages to a client on a station 14a only when new information is available that requires synchronization. The access point 14b can then monitor for such notifications, that may be called “alert packets” herein. Thus, when the access point 14b recognizes an alert packet, it realizes that this is information which the station 14a should be involved in receiving. Other messages that do not include alert packages may then be discarded.

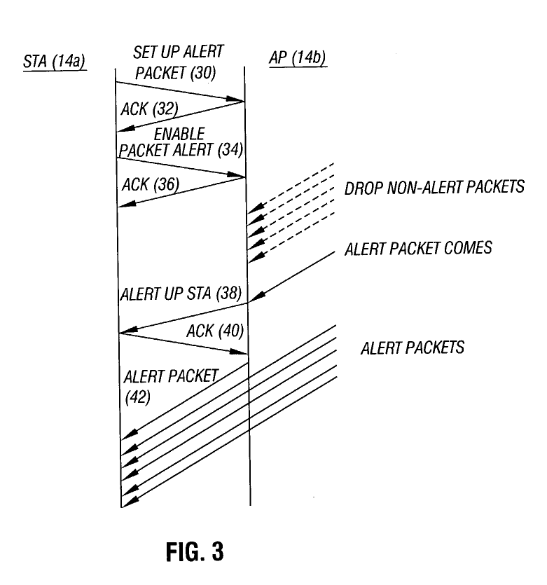

Referring to FIG. 3, wireless communications may occur between the access point 14b and the station 14a in response to information conveyed over a wired network from the server 15. In some embodiments, the host 18 may be a portable processor-based system or other power sensitive system.

The host 18 may be unnecessarily burdened by the receipt of relatively unimportant packets sent, for example, by the server 15. Each time such a packet 15 arrives, absent appropriate filtering, the host 18 must expend cycles dealing with the message. Such cycles may effectively increase the power consumption of the host 18. In battery powered applications, this reduces the useful life between battery charges of the host 18, reducing its desirability and performance.

As shown in FIG. 3, a packet filtering protocol, implemented on the access point 14b, filters unnecessary packets that would unnecessarily burden the host 18, causing the host 18 to unnecessarily consume power.

Initially, the station 14a sends a setup alert packet 30 to the access point 14b. The access point 14b provides an acknowledgment (ACK) 32 to the station 14a. The setup alert packet 30 provides the information needed by the access point 14b to determine which packets are of sufficient importance to involve the host 18. Thus, a filtering protocol may be provided from the station 14a to the access point 14b to enable the access point 14b to determine whether to burden the host 18 with an incoming packet. This information may be received by the station 14a from the host 18 and particularly the processor 20. The station 14a may then enable the packet filtering function on the access point 14b as indicated at 34, and this enable the message may be acknowledged as indicated at 36.

Any “Non-Alert Packets” that arrive at the access point 14b from the server 15 that do not meet the criteria provided by the host 18 for involving the host 18 are simply dropped in one embodiment. When an alert packet arrives (“Alert Packet Comes”) the packet is transferred to the station as indicated at 38. An alert packet is a packet that meets the criteria provided by the host 18 for involving the host. The station 14a acknowledges the packet as indicated at 40. The host 18 then receives the data packets included with the communication from the server 15 as indicated at 42.

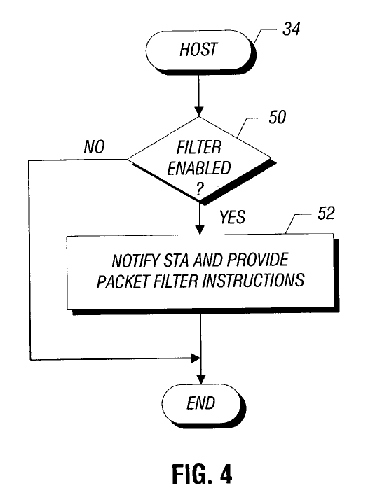

Referring to FIG. 4, in one embodiment, the software 34 stored on the host 18 initially determines whether the host desires to implement packet filtering as indicated at diamond 50. If so, the host 18 notifies the station 14 and provides the appropriate packet filter instructions as indicated in block 52.

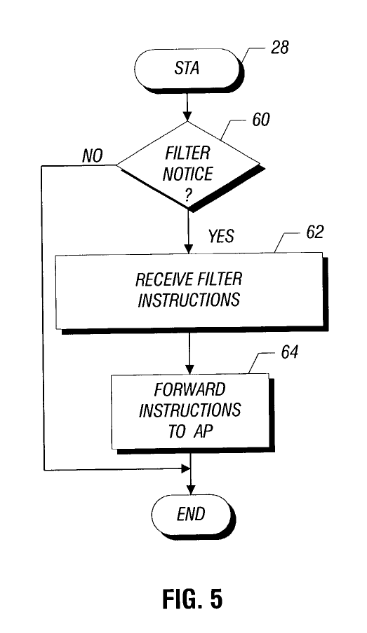

Referring to FIG. 5, in one embodiment, the station software 28 initially determines whether a notice has been received from the host 18 that the host requests packet filtering, as determined in diamond 60. If so, the station receives the packet filtering instructions as indicated in block 62. The station then forwards those instructions to the access point as indicated in block 64.

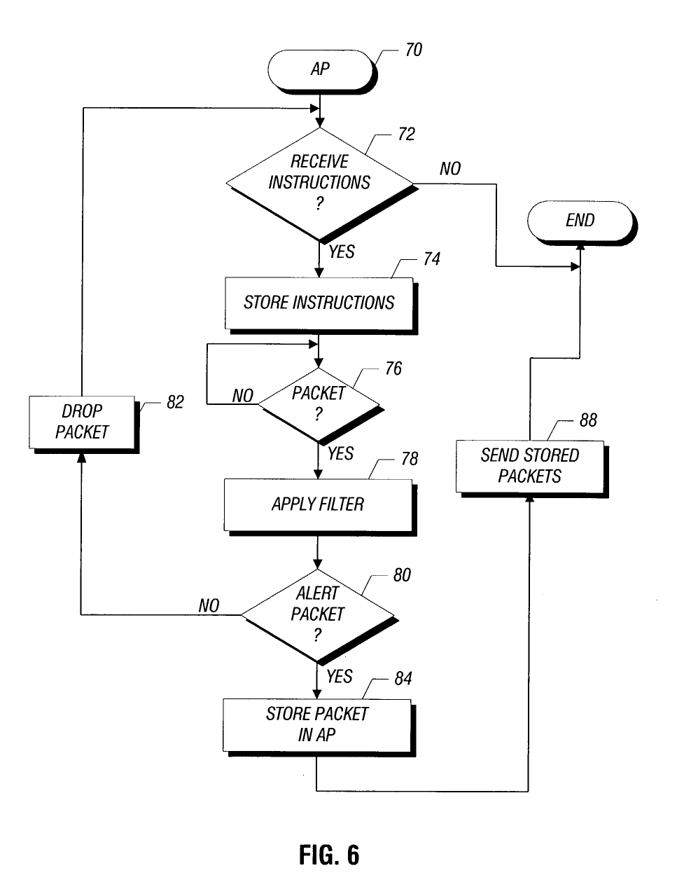

Turning to FIG. 6, the access point software 70, in accordance with one embodiment of the present invention, determines whether it has received packet filtering instructions as indicated in diamond 72. If not, after a time out, the flow ends. If the instructions have been received, those instructions may be stored as indicated in block 74. When a packet arrives at the access point, for example over the network from the server 15, the filtering instructions are applied, as indicated in block 78.

A check at diamond 80 determines whether the packet is an alert packet meaning that it is a packet which necessitates involving the host 18. If not, in some embodiments, the packet may simply be dropped as indicated in block 82.

If the packet is an alert packet, the packet is stored in the access point 14b temporarily as indicated in block 84 in one embodiment. The stored packet is sent to the station 14a which in turn transfers the packet or packets to the host 18.

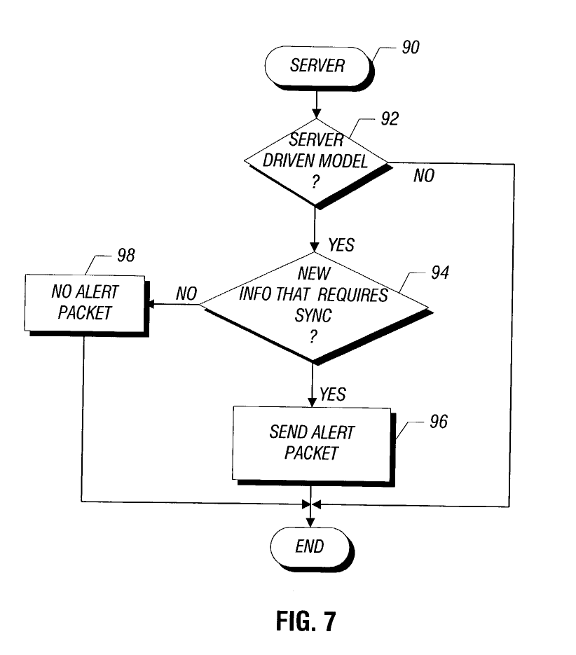

Referring to FIG. 7, the server software 90 begins by determining whether a server driven model has been elected as determined at diamond 92. If so, the server determines whether new information is available that requires synchronization as indicated at diamond 94. If received information requires synchronization, then an alert packet is sent over the DS as indicated at block 96. Otherwise, no such alert message is sent as indicated at block 98. In this way, only those messages which are important to the station may be originated from the server 15 reducing traffic and reducing the burden on the station 14. This ultimately may reduce its power consumption.

In some embodiments of the present invention, a station is made aware of buffered medium access control (MAC) protocol data units by the state of a bit assigned to the station in a traffic indication map and in a directed traffic indication map, both of which are managed by the access point. These maps may be broadcast to the access point in beacon frames. Beacon frames are broadcast in advertised intervals known as beacon intervals. When a station receives a beacon frame and finds that its bit is set in the maps, the station may then be required to transmit a message to an access point to receive buffered MAC protocol data units. Thus, in some embodiments of the present invention, the access point simply fails to indicate in the maps that the MAC protocol data unit is available, allowing the station to simply ignore those protocol data units. However, when the MAC protocol units constitute an alert message which is of importance to the particular station, then the access point sets the appropriate indicators in the maps to cause the station to retrieve the protocol data units.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing an access point in a wireless network with packet filtering instructions;
enabling an access point to wirelessly receive a packet; and
enabling said access point to determine, using said packet filtering instructions, whether to involve a host.

2. The method of claim 1 including receiving the instructions from a station coupled to the host.

3. The method of claim 2 including wirelessly receiving said instructions.

4. The method of claim 1 including receiving information from a server that indicates whether the host should be involved.

5. The method of claim 4 including receiving a packet and determining whether the packet is an alert packet involving the host.

6. The method of claim 5 including, if the packet is an alert packet, enabling a station coupled to said host to receive said packet.

7. The method of claim 6 including storing an alert packet in the access point.

8. The method of claim 6 including setting a bit depending on whether a packet is an alert packet.

9. The method of claim 6 including receiving an alert packet from an information services server over a wired network.

10. The method of claim 1 including dropping packets that do not meet the criteria for involving the host.

11. An article comprising a medium storing instructions that, if executed, enable a processor-based system to perform the steps of:
providing distribution services;
receiving packet filtering instructions from a host before the host transitions to a reduced power consumption state;
receiving a wireless packet; and
applying said packet filtering instructions to said packet to determine whether to involve the host.

12. The article of claim 11 further storing instructions that enable a processor-based system to receive instructions from a station coupled to the host.

13. The article of claim 12 further storing instructions that enable the processor-based system to wirelessly receive information from a server that indicates whether the host should be involved with the packet.

14. The article of claim 13 further storing instructions that enable a processor-based system to receive a packet and determine whether the packet is one which merits involving the host.

15. The article of claim 14 further storing instructions that enable a processor-based system to notify a station coupled to the host if a received packet is an alert packet that merits involving the host.

16. The article of claim 15 further storing instructions that enable a processor-based system to store an alert packet intended for the host.

17. The article of claim 16 further storing instructions that enable the processor-based system to set a bit in a map depending on whether the packet is an alert packet.

18. The article of claim 11 further storing instructions that enable a processor-based system to receive a packet from an information services server over a wired network.

19. The article of claim 11 further storing instructions that enable the processor-based system to drop packets that do not meet criteria for involving the host.

20. An access point comprising:
a processor; and
a storage, coupled to said processor, storing instructions that enable the processor to receive packet filtering instructions, receive a wireless packet and apply said packet filtering instructions to said packet to determine whether to involve the host in processing a packet.

21. The access point of claim 20 wherein said storage stores instructions that enable the access point to receive instructions from a station coupled to the host.

22. The access point of claim 21 wherein said access point receives a packet, applies said filtering instructions and determines whether to involve the host.

23. The access point of claim 22 wherein said storage stores a packet intended for the host.

24. A processor-based system comprising:
a processor;
a storage coupled to said processor;
a bus coupled to said processor; and
a station coupled to said bus to receive wireless packets, said station acting as an access point, said access point to receive packet filtering instructions from a host and to apply the packet filtering instructions to determine whether to involve the host in processing a packet.

25. The system of claim 24 wherein said system is a battery powered system.

26. The system of claim 24 wherein said station is a network interface card.

27. The system of claim 26 wherein said network interface card is directly coupled to a wired network.

28. The system of claim 26 wherein said access point stores a packet until the system is ready to receive the packet.

29. A server comprising:
a processor; and
a storage coupled to said processor storing instructions to determine whether a packet is one which should be processed by a particular host and to forward said packet to an access point with an indication to enable said access point to determine whether to involve said host in processing the packet.

30. The server of claim 29 wherein said server is an information services server for a wireless network.
